(19) United States
(12) Patent Application Publication
(10) Pub. No.: US 2013/0142472 A1
(43) Pub. Date: Jun. 6, 2013

(54) OPTICAL TRANSMITTER AND OPTICAL TRANSMISSION METHOD

(71) Applicant: Fujitsu Optical Components Limited, Kawasaki-shi (JP)

(72) Inventor: Toru Yamazaki, Yokohama (JP)

(73) Assignee: Fujitsu Optical Components Limited, Kawasaki-shi (JP)

(21) Appl. No.: 13/655,973

(22) Filed: Oct. 19, 2012

(30) Foreign Application Priority Data
Dec. 6, 2011 (JP) 2011-267356

(51) Int. Cl. G02F 1/035

(52) U.S. Cl. 385/3

(57) ABSTRACT

An optical transmitter includes a first Mach-Zehnder, second Mach-Zehnders, a plurality of electrodes and a shift circuit. The first Mach-Zehnder is formed in an LN substrate. The second Mach-Zehnders are formed in branch waveguides of the first Mach-Zehnder. The plurality of electrodes are set in the second Mach-Zehnders and modulate lights input in the second Mach-Zehnders using an electric potential of the electrodes. The shift circuit causes a phase difference between the lights modulated in the above plurality of electrodes and output from the second Mach-Zehnders. The Mach-Zehnder synthesizes the above lights of different phases and generates an output signal.

### CROSS-REFERENCE TO RELATED APPLICATION

This application is based upon and claims the benefit of priority of the prior Japanese Patent Application No. 2011-267356, filed on Dec. 6, 2011, the entire contents of which are incorporated herein by reference.

### FIELD

The embodiments discussed herein are related to an optical transmitter and an optical transmission method.

### BACKGROUND

In the related art, in an optical transmitter that transmits an optical signal via a transmission path, there is an optical transmitter that modulates an optical signal using a QAM (Quadrature Amplitude Modulation) scheme (hereinafter referred to as “optical QAM modulation”). In such an optical transmitter, the CW (Continuous Wavelength) laser light input as an optical signal is diffused in one Mach-Zehnder and subsequently output to each branch waveguide (hereinafter referred to as “arm”). Each arm is provided with a plurality of electrodes, and, when a binary electric potential of “1” or “0” (i.e. High or Low) is given from a drive circuit to each electrode, a phase of the above optical signal changes. Therefore, by synthesizing these two optical signals of different phases at the time of output from Mach-Zehnder, the optical QAM modulation is realized.
[Patent Literature 1] Japanese National Publication of International Patent Application No. 2010-534997
[Patent Literature 2] Japanese Laid-open Patent Publication No. 2010-072462
[Patent Literature 3] U.S. Patent No. 2010/0156679
[Patent Literature 4] U.S. Patent No. 2011/0044573

However, in the above optical QAM modulation technique, there are the following problems. That is, in an optical transmitter, an electrode and a corresponding drive circuit may be increased to suppress degradation of transmission quality in the optical QAM modulation. For example, in a case where the optical transmitter performs 16-QAM modulation, six electrodes and six drive circuits are set, that is, the number of parts to be mounted increases and therefore it is expensive. Also, according to transition in a coding state of the optical QAM, the phase and amplitude of an optical signal varies and therefore chirp (i.e. frequency variation) may occur. The chirp occurrence degrades a transmission waveform of the optical signal and causes degradation of transmission quality. The degradation of the transmission quality due to the chirp is significant especially when the distance of an optical transmission path is enough long to cause waveform degradation due to a transmission delay.

### SUMMARY

According to an aspect of the embodiments, an optical transmitter includes: a first Mach-Zehnder-type optical waveguide formed in an LN (Lithium Niobate) substrate; second Mach-Zehnder-type optical waveguides formed in branch waveguides of the first Mach-Zehnder-type optical waveguide; a plurality of electrodes that are set in the second Mach-Zehnder-type optical waveguides and modulate lights input in the second Mach-Zehnder-type optical waveguides using an electric potential of the electrodes; and a shift circuit that causes a phase difference between the lights modulated in the plurality of electrodes and output from the second Mach-Zehnder-type optical waveguides, wherein the first Mach-Zehnder-type optical waveguide synthesizes the lights of different phases and generates an output signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating one example of a configuration of an optical transmission system according to the present embodiment;

FIG. 2 is a diagram illustrating one example of a configuration of an optical transmitter according to the present embodiment;

FIG. 3 is a diagram illustrating one example of a configuration of an optical QAM modulator according to the present embodiment;

FIG. 4 is a diagram illustrating one example of relationships between the electric potentials of electrodes and an optical phase difference, in the case of using different electrode lengths and drive circuit output values at the identical amplitude;

FIG. 5 is a diagram illustrating one example of relationships between the electric potentials of electrodes and an optical phase difference, in the case of using the identical electrode length and drive circuit output values at different amplitudes;

FIG. 6 is a diagram illustrating one example of a delay difference caused between output signals from drive circuits;

FIG. 7 is a diagram illustrating one example of a configuration of an optical QAM modulator according to modification 1;

FIG. 8 is a diagram illustrating one example of a configuration of an optical QAM modulator according to modification 2;

FIG. 9 is a diagram illustrating one example of relationships between the electric potentials of electrodes and an optical phase difference in modification 3;

FIG. 10 is a diagram illustrating one example of a configuration of an optical QAM modulator according to modification 3; and

FIG. 11 is a diagram illustrating one example of relationships between the electric potentials of electrodes and an optical phase difference in modification 4.

### DESCRIPTION OF EMBODIMENTS

Preferred embodiments will be explained with reference to accompanying drawings. Also, the optical transmitter and the optical transmission method disclosed in the present application are not limited to the following embodiments.

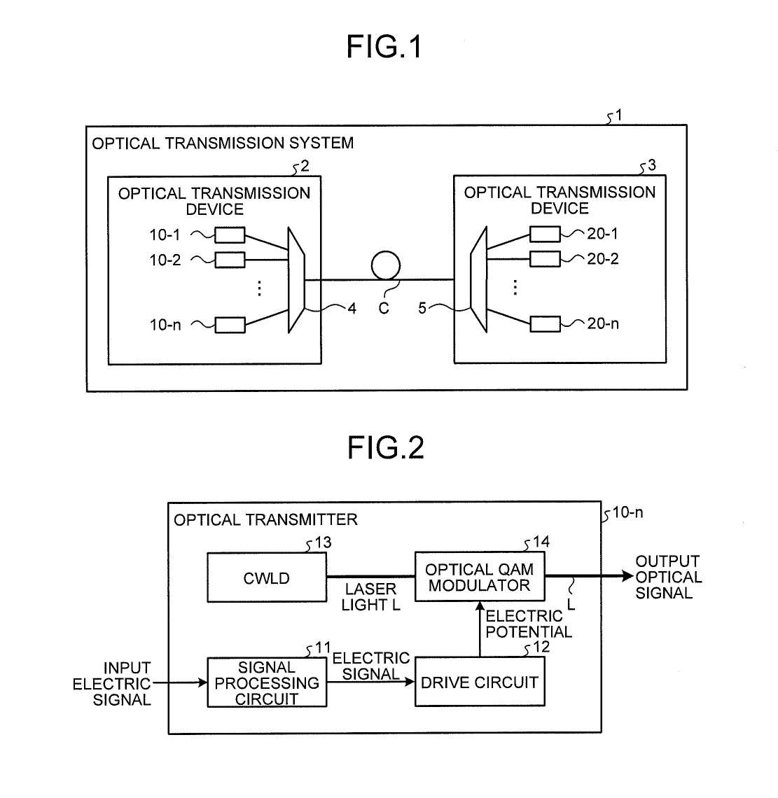

First, a configuration of the optical transmission system according to the present embodiment will be explained. The optical transmission system performs transmission and reception of optical signals using a WDM (Wavelength Division Multiplex) scheme. FIG. 1 is a diagram illustrating one example of a configuration of an optical transmission system 1 according to the present embodiment. As illustrated in FIG. 1, an optical transmission device 2 on the transmission side and an optical transmission device 3 on the reception side are provided and each connected to an optical transmission path C. Further, the optical transmission device 2 has n (which is a natural number) optical transmitters 10-1 to 10-n. The optical transmission device 2 synthesizes signals of different wavelengths output from the optical transmitters 10-1 to 10-n by a synthesis circuit 4 and transmits a synthesized signal to the optical transmission path C as an optical signal. Meanwhile, the optical transmission device 3 has a similar configuration to that of the optical transmission device 2 and diffuses the optical signal received via the optical transmission path C into a plurality of signals of different optical wavelengths by a division circuit 5. The diffused optical signals are input in optical receivers 20-1 to 20-n and photoelectric-converted into electric signals.

Next, as a configuration example of the optical transmitters 10-1 to 10-n, a configuration of the optical transmitter 10-n will be explained as a representative. FIG. 2 is a diagram illustrating one example of the configuration of the optical transmitter 10-n according to the present embodiment. As illustrated in FIG. 2, the optical transmitter 10-n includes a signal processing circuit (i.e. multiplexer) 11, a drive circuit 12, a CWLD (Continuous Wavelength Laser Diode) 13 and an optical QAM modulator 14. These components are connected such that signals and data are input or output in one direction or two directions.

The signal processing circuit 11 converts an input electric signal into a signal capable of optical QAM modulation and outputs it to the drive circuit 12. The drive circuit 12 outputs an electric potential to perform external modulation of light in the optical QAM modulator 14, to the optical QAM modulator 14, based on the signal processed in the signal processing circuit 11. The CWLD 13 outputs laser light L of continuous waves to the optical QAM modulator 14. The optical QAM modulator 14 performs external modulation of the laser light L input from the CWLD 13, using the electric potential input by the drive circuit 12. Here, among the optical transmitters 10-1 to 10-n, the other optical transmitters than the optical transmitter 10-n have a similar configuration to that of the optical transmitter 10-n, and therefore their drawings and specific explanation will be omitted.

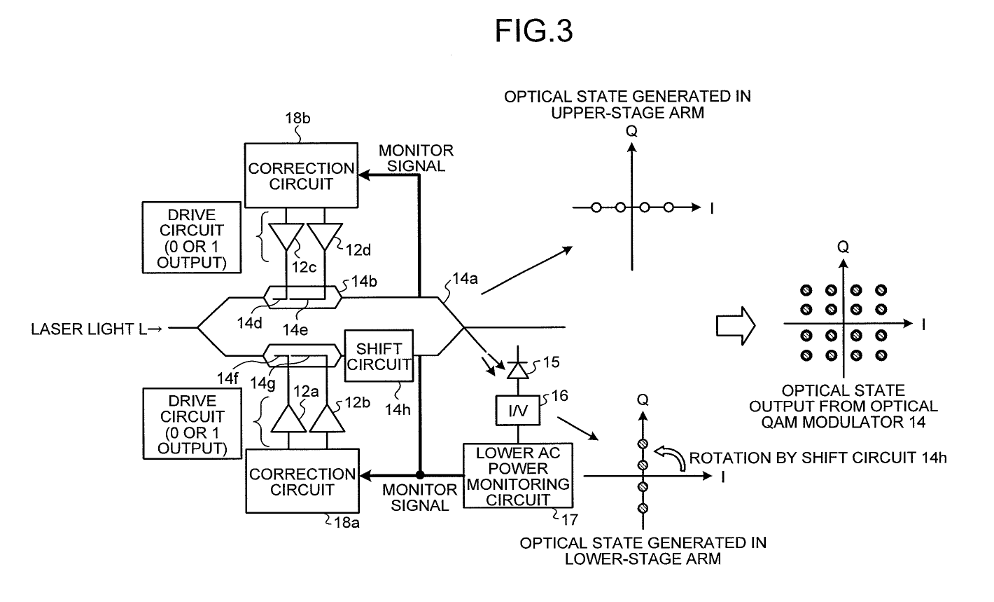

FIG. 3 is a diagram illustrating one example of a configuration of the optical QAM modulator 14 in the case of 16-QAM. As illustrated in FIG. 3, the optical QAM modulator 14 includes a first Mach-Zehnder 14a, second Mach-Zehnders 14b and 14c, a plurality of electrodes 14d to 14g and a shift circuit 14h. The first Mach-Zehnder 14a is subjected to diffusional formation so as to be embedded in a substrate formed with LN (Lithium Niobate) and diffuses the laser light L input from the CWLD 13. The second Mach-Zehnders 14b and 14c are formed in the arms of the first Mach-Zehnder 14a and each provided with two electrodes (i.e. four electrodes 14d to 14g in total). In these plurality of electrodes 14d to 14g, an electric potential is applied by a binary code signal (0 or 1) input from four drive circuits 12a to 12d according to a signal processed in the signal processing circuit 11. The optical QAM modulator 14 generates an output signal based on the electric potentials of the plurality of electrodes 14d to 14g. The shift circuit 14h causes a phase difference between optical signals output from the second Mach-Zehnders 14b and 14c.

The second Mach-Zehnders 14b and 14c and the electrodes 14d to 14g generate signals in which the phase (0 or π) and the amplitude (intensity) are mutually different, by the electric potentials given by the drive circuits 12a to 12d. That is, in the upper-stage arm of the first Mach-Zehnder 14a, four optical states (i.e. four values) are generated by the second Mach-Zehnder 14b and the electrodes 14d and 14e. Also, in the lower-stage arm of the first Mach-Zehnder 14a, four optical states (i.e. four values) are generated by the second Mach-Zehnder 14c and the electrodes 14f and 14g. However, the output light from the second Mach-Zehnder 14c is output in a state where the phase is shifted by π/2 from the output light from the second Mach-Zehnder 14b. Subsequently, the output signals from the upper and lower arms are synthesized at the time of the output in the first Mach-Zehnder 14a, and, as a result, there are 16 kinds of states of light output from the first Mach-Zehnder 14a and optical modulation by 16-QAM is realized. The signal subjected to optical modulation by 16-QAM is output as an optical signal from the optical QAM modulator 14.

Also, although the optical states generated by the electrodes 14f and 14g are determined by the electrode configurations and the drive circuits, methods of generating light of different states in the electrodes 14f and 14g include two methods described below, for example. First, while the electrode lengths of the electrodes 14f and 14g have different values, the drive circuits 12a and 12b output signals of the same amplitude value to the electrodes 14f and 14g. Second, while the electrode lengths of the electrodes 14f and 14g have the same value, the drive circuits 12a and 12b output signals of different amplitude values to the electrodes 14f and 14g.

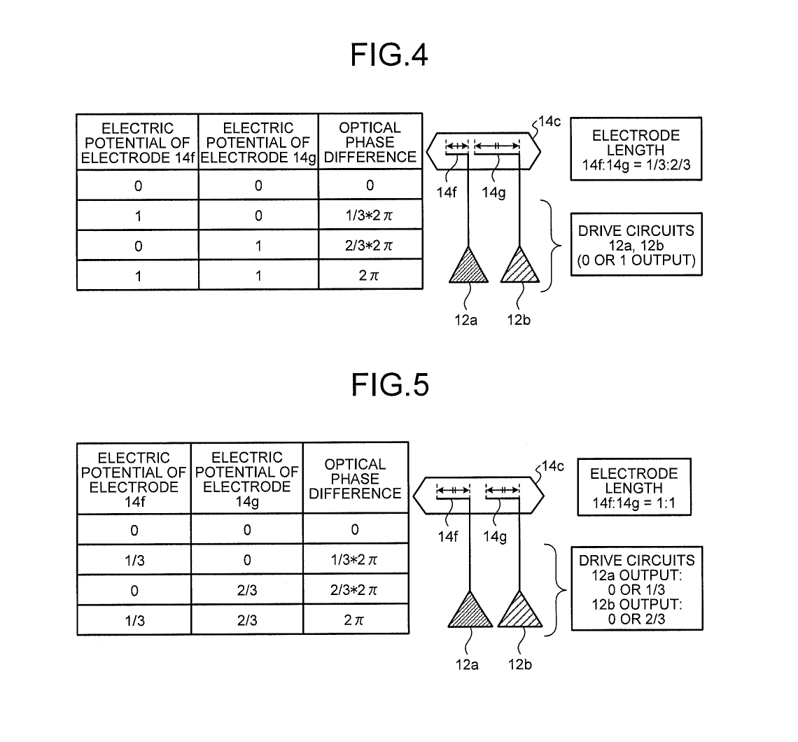

FIG. 4 is a diagram illustrating one example of relationships between the electric potentials of the electrodes 14f and 14g and an optical phase difference, in the case of using different electrode lengths and drive circuit output values at the identical amplitude. As illustrated in FIG. 4, “1/3:2/3” is set as a ratio of the electrode lengths of the electrodes 14f and 14g. Also, it is assumed that the output signals (i.e. the above code signals) from the drive circuits 12a and 12b have a value of 0 or 1 as an output value in both the electrodes 14f and 14g. In this case, the electrode lengths are determined such that the phase difference of light diffused by the second Mach-Zehnder 14c is 2π in cases where an electric potential of “0” is given to the electrodes 14f and 14g and where an electric potential of “1” is given to the electrodes 14f and 14g.

Since the optical phase variation is proportional to an electrode length, the optical phase difference caused by the electric potentials of the electrodes 14f and 14g has the value illustrated in FIG. 4. That is, in a case where the electric potentials of the electrodes 14f and 14g are “0” and “0,” the optical phase difference is “0,” and, in a case where the electric potentials of the electrodes 14f and 14g are “1” and “0,” the optical phase difference is “2π/3.” Also, in a case where the electric potentials of the electrodes 14f and 14g are “0” and “1,” the optical phase difference is “4π/3,” and, in a case where the electric potentials of the electrodes 14f and 14g are “1” and “1,” the optical phase difference is “2π.” When two lights of the above phase differences are synthesized at the time of the output from the second Mach-Zehnder 14c, four optical states (i.e. four values) are generated. Further, since the phase difference of the output light from one second Mach-Zehnder 14c is shifted by π/2, when it is synthesized with the output light from the other second Mach-Zehnder 14b at the time of the output from the first Mach-Zehnder 14a, optical QAM modulation by 16-QAM is performed.

FIG. 5 is a diagram illustrating one example of relationships between the electric potentials of the electrodes 14f and 14g and an optical phase difference, in the case of using the identical electrode length and drive circuit output values at different amplitudes. As illustrated in FIG. 5, “1:1” is set as a ratio of the electrode lengths of the electrodes 14f and 14g. Also, it is assumed that the output signals (i.e. the above code signals) from the drive circuits 12a and 12b have different amplitude values depending on the electrodes 14f and 14g and a ratio of the maximum amplitude values is set to “1/3:2/3.” In this case, the absolute values of the amplitudes of output signals from the drive circuits 12a and 12b are determined such that the phase difference of diffused light is 2π in cases where an electric potential of “0” is given to the electrodes 14f and 14g and where electric potentials of “1/3” and “2/3” are given to the electrodes 14f and 14g, respectively.

Since the optical phase variation is proportional to an electrode length, the optical phase difference caused by the electric potentials of the electrodes 14f and 14g has the value illustrated in FIG. 5. That is, in a case where the electric potentials of the electrodes 14f and 14g are “0” and “0,” the optical phase difference is “0,” and, in a case where the electric potentials of the electrodes 14f and 14g are “1/3” and “0,” the optical phase difference is “2π/3.” Also, in a case where the electric potentials of the electrodes 14f and 14g are “0” and “2/3,” the optical phase difference is “4π/3,” and, in a case where the electric potentials of the electrodes 14f and 14g are “1/3” and “2/3,” the optical phase difference is “2π.” When two lights of the above phase differences are synthesized at the time of the output from the second Mach-Zehnder 14c, four optical states (i.e. four values) are generated. Further, since the phase difference of the output light from one second Mach-Zehnder 14c is shifted by π/2, when it is synthesized with the output light from the other second Mach-Zehnder 14b at the time of the output from the first Mach-Zehnder 14a, optical QAM modulation by 16-QAM is performed.

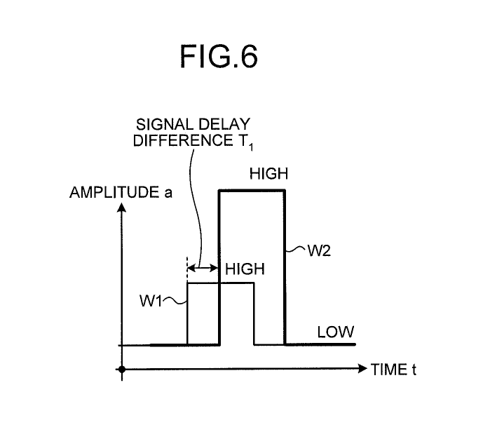

Here, like the optical transmitter 10-n according to the present embodiment, in a case where there are a plurality of drive circuits to give an electric potential to an electrode, a phase delay difference may be caused between output signals from the drive circuits 12a and 12b. This delay difference is caused by, for example, the variation in the electric signal line lengths from the drive circuits 12a and 12b to the corresponding second Mach-Zehnder 14c or an input signal delay to the drive circuits 12a and 12b. FIG. 6 is a diagram illustrating one example of a delay difference caused between output signals from drive circuits. In FIG. 6, time “t” is defined in the x axis and amplitude “a” is defined in the y axis. As illustrated in FIG. 6, output waveform W1 from the drive circuit 12a and output waveform W2 from the drive circuit 12b have waveforms of different amplitude values in the High state. Also, signal delay difference T₁ is caused between these two output signals of different amplitudes. The signal delay difference T₁ is a cause of degradation of transmission quality of an optical signal subjected to QAM modulation.

Therefore, to correct the above delay difference, as illustrated in FIG. 3, the optical transmitter 10-n includes a PD (Photo Diode) 15, an IV conversion circuit (I/V) 16, a lower AC (Alternating Current) power monitoring circuit 17 and correction circuits 18a and 18b. The PD 15 monitors the light output from the first Mach-Zehnder 14a. The IV conversion circuit 16 converts a current input from the PD 15 into a voltage. The lower AC power monitoring circuit 17 monitors and detects an alternating current power of the voltage converted in the IV conversion circuit 16. The correction circuits 18a and 18b control the phase differences between the output signals from the drive circuits 12a to 12d, using the value of the alternating current power.

To be more specific, if a phase difference occurs between the output signals from the drive circuits 12a to 12d, the electric spectrum of outputs from the PD 15 and the IV conversion circuit 16 decreases on the lower side. Accordingly, an output value (i.e. alternating current power value) from the lower AC power monitoring circuit 17 decreases. Meanwhile, the alternating current power value increases as the above phase difference decreases, and the alternating current power value has a local maximum value when the phase difference is “0.” Therefore, the correction circuits 18a and 18b correct the signal delay difference T₁ by changing the phases of signals output from the drive circuits 12a to 12d such that the above alternating current power value input from the lower AC power monitoring circuit 17 is maximum.

For example, since it is possible to decide that the phase difference further increases in a case where the alternating current power value decreases when the phase of the drive circuit 12a out of the plurality of drive circuits 12a and 12b is delayed, the correction circuit 18a performs control of advancing the phase of the output signal from the drive circuit 12a. By contrast, in a case where the alternating current power value decreases when the phase of the drive circuit 12a out of the plurality of drive circuits 12a and 12b is advanced, the correction circuit 18a delays the phase of the output signal from the drive circuit 12a. Also, since it is possible to decide that the phase difference decreases in a case where the alternating current power value increases when the phase of the drive circuit 12a out of the plurality of drive circuits 12a and 12b is delayed, the correction circuit 18a performs control of further delaying the phase of the output signal from the drive circuit 12a. By contrast, in a case where the alternating current power value increases when the phase of the drive circuit 12a out of the plurality of drive circuits 12a and 12b is advanced, the correction circuit 18a further advances the phase of the output signal from the drive circuit 12a until the power value becomes maximum. Thus, by the correction circuits 18a and 18b, the optical transmitter 10-n adjusts the phase delay difference using the alternating current power value as a parameter and improves optical transmission quality degraded due to a cause of the phase delay difference. As a result, good transmission quality is maintained.

As described above, the optical transmitter 10-n includes the first Mach-Zehnder (i.e. main Mach-Zehnder) 14a, the second Mach-Zehnders (i.e. sub-Mach-Zehnders) 14b and 14c, the plurality of electrodes 14d to 14g and the shift circuit 14h. The first Mach-Zehnder 14a is formed on an LN substrate. The second Mach-Zehnders 14b and 14c are formed in each branch waveguide (i.e. arm) of the first Mach-Zehnder 14a. The plurality of electrodes 14d to 14g are set in the second Mach-Zehnders 14b and 14c to modulate the light input in the second Mach-Zehnders 14b and 14c using the electric potentials (i.e. two values of “0” or “1”) of the electrodes. The shift circuit 14h causes a phase difference between the lights which are modulated in the plurality of electrodes 14d to 14g and output from the second Mach-Zehnders 14b and 14c. The first Mach-Zehnder 14a synthesizes the above lights of different phases and generates an output signal. Also, the optical transmitter 10-n includes the plurality of drive circuits 12a to 12d, the lower AC power monitoring circuit 17 and the correction circuits 18a and 18b. The plurality of drive circuits 12a to 12d give an electric potential to the plurality of electrodes 14d to 14g. The lower AC power monitoring circuit 17 monitors the alternating current power based on the light output from the first Mach-Zehnder 14a. The correction circuits 18a and 18b corrects the phase difference in the signals output from the plurality of drive circuits 12a to 12d using the above alternating current.

As described above, the numbers of electrodes and drive circuits requested to realize optical 16-QAM in the optical QAM modulator 14 according to the present embodiment are 4, which are greatly lower than 12 (6×2) in the related art. Especially, a sufficient number of drive circuits requested for the device configuration is the number of transmission symbols (i.e. 4 (=2×2) in the case of optical 16-QAM modulation). Accordingly, the number of parts to be mounted on the optical transmitter 10-n decreases. Therefore, it is possible to easily configure the optical transmitter 10-n at a lower cost. Also, the optical QAM modulator 14 performs phase modulation in the electrodes 14d to 14g set on the second Mach-Zehnders 14b and 14c, and therefore the phase and amplitude (i.e. intensity) in optical signals is reduced and a chirp occurrence is suppressed. The chirp occurrence degrades the transmission waveform of optical signals and causes transmission quality to degrade, and, consequently, by preventing the chirp, the degradation of the transmission quality is suppressed regardless of the distance of an optical transmission path. As a result, the transmission quality after the optical transmission is improved compared to the related art.

Also, the first Mach-Zehnder 14a is subjected to diffusional formation in an LN substrate, and the first Mach-Zehnder 14a embedded in the LN substrate includes the plurality of electrodes 14d to 14g in the second Mach-Zehnders 14b and 14c formed in each arm. Accordingly, the optical transmitter 10-n can generate a multivalued modulation signal without causing an optical loss due to the phase variation caused in a semiconductor Mach-Zehnder. Therefore, in the optical transmitter 10-n, since an electrode needs not be separately set to correct the above optical loss and non-linear characteristics, it is possible to effectively perform QAM modulation with a smaller number of parts. Further, since an occurrence of the optical loss degrades an average optical output level, when the laser light L input from the CWLD 13 is equivalent, the optical transmitter 10-n can transmit an optical signal at a higher output than other optical transmitters in which an LN substrate is not used.

Also, the optical transmitter 10-n includes the plurality of electrodes 14d to 14g in the second Mach-Zehnders 14b and 14c formed in each arm of the first Mach-Zehnder 14a. Therefore, by setting the plurality of drive circuits 12a to 12d that output a two-valued electric potential, the optical transmitter 10-n can perform modulation by 16-QAM or more, without a drive circuit that outputs a multivalued electric potential.

Modification 1

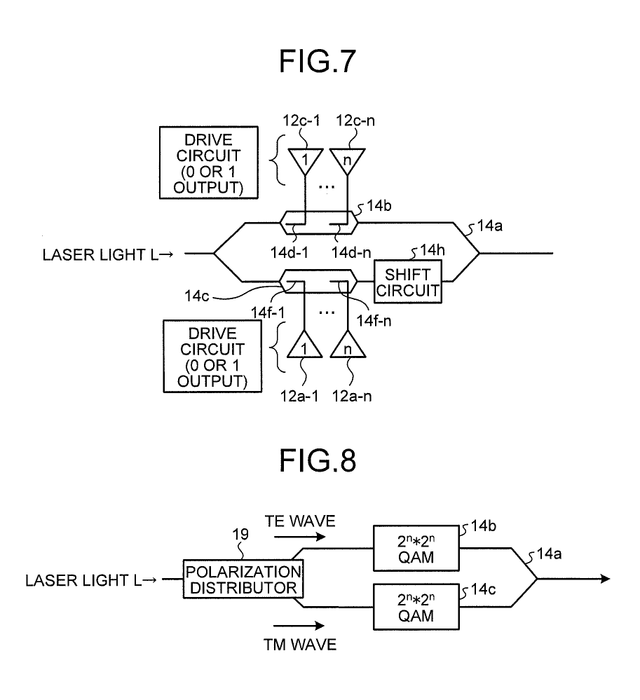

Although the configuration and operation of the optical QAM modulator 14 have been described above using 16-QAM modulation as an example, by setting n (which is a natural number) electrodes in each of the second Mach-Zehnders 14b and 14c, the optical QAM modulator 14 can realize 2ⁿ×2ⁿ-QAM modulation. FIG. 7 is a diagram illustrating one example of a configuration of the optical QAM modulator 14 according to modification 1 (in the case of 2ⁿ×2ⁿ-QAM). As illustrated in FIG. 7, the second Mach-Zehnders 14b and 14c n electrodes 14d-1 to 14d-n and n electrodes 14f-1 to 14f-n, respectively. Also, the electrodes 14d-1 to 14d-n and 14f-1 to 14f-n are connected to n drive circuits 12c-1 to 12c-n and n drive circuits 12a-1 to 12a-n, respectively, to give an electric potential. Accordingly, by phase modulation of the input light in each electrode, it is possible to generate 2ⁿ optical states every second Mach-Zehnder. Therefore, by giving a phase difference of π/2 to the output lights from the second Mach-Zehnders 14b and 14c, the optical QAM modulator 14 can generate 2ⁿ×2ⁿ kinds of optical states (i.e. values). As a result, 2ⁿ×2ⁿ-QAM modulation is realized.

Modification 2

Further, as another variation aspect, the optical transmitter 10-n may include a polarization distributor 19 that diffuses the output light from the CWLD 13. That is, the optical transmitter 10-n may further include the polarization distributor 19 that diffuses the input laser light L to generate two orthogonal polarization lights and outputs each polarization light to each branch waveguide (i.e. arm) of the first Mach-Zehnder 14a. FIG. 8 is a diagram illustrating one example of a configuration of the optical QAM modulator 14 according to modification 2 (in the case of dual-polarization-type 2ⁿ×2ⁿ-QAM). As illustrated in FIG. 8, the optical QAM modulator 14 diffuses the laser light L input from the CWLD 13 by the polarization distributor 19 to generate light of two orthogonal polarizations (i.e. TE (Transverse Electric) wave and TM (Transverse Magnetic) wave). The second Mach-Zehnder 14b performs 2ⁿ×2ⁿ-QAM modulation on the TE wave light and the second Mach-Zehnder 14c performs 2ⁿ×2ⁿ-QAM modulation on the TM wave light. Accordingly, the optical transmitter 10-n can realize the dual-polarization-type 2ⁿ×2ⁿ-QAM.

Modification 3

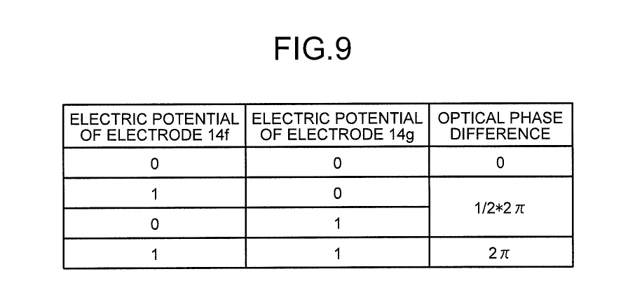

Also, by applying an equal electrode length to the polarization distributor 19, the optical transmitter 10-n can realize orthogonal duo-binary modulation in addition to 2ⁿ×2ⁿ-QAM modulation. That is, in the optical transmitter 10-n, the plurality of drive circuits 12a to 12d may output signals of respective amplitudes to the plurality of electrodes 14d to 14g, and the plurality of electrodes 14d to 14g may perform orthogonal duo-binary modulation on the above light using the above signals of respective amplitudes and the electric potential of each electrode. FIG. 9 is a diagram illustrating one example of relationships between the electric potentials of the electrodes 14f and 14g and an optical phase difference in modification 3, in the case of using the identical electrode length and drive circuit output values at different amplitudes. When the drive circuits 12a to 12d give output signals of different amplitudes to electrodes of the identical length (see FIG. 5), the optical QAM modulator 14 can acquire optical phase states as illustrated in FIG. 9. That is, in a case where the electric potentials of the electrodes 14f and 14g are “0” and “0,” the optical phase difference is “0,” and, in a case where the electric potentials of the electrodes 14f and 14g are “1” and “0,” the optical phase difference is “π.” Also, in a case where the electric potentials of the electrodes 14f and 14g are “0” and “1,” the optical phase difference is “π.” Also, in a case where the electric potentials of the electrodes 14f and 14g are “1” and “1,” the optical phase difference is “2π.”

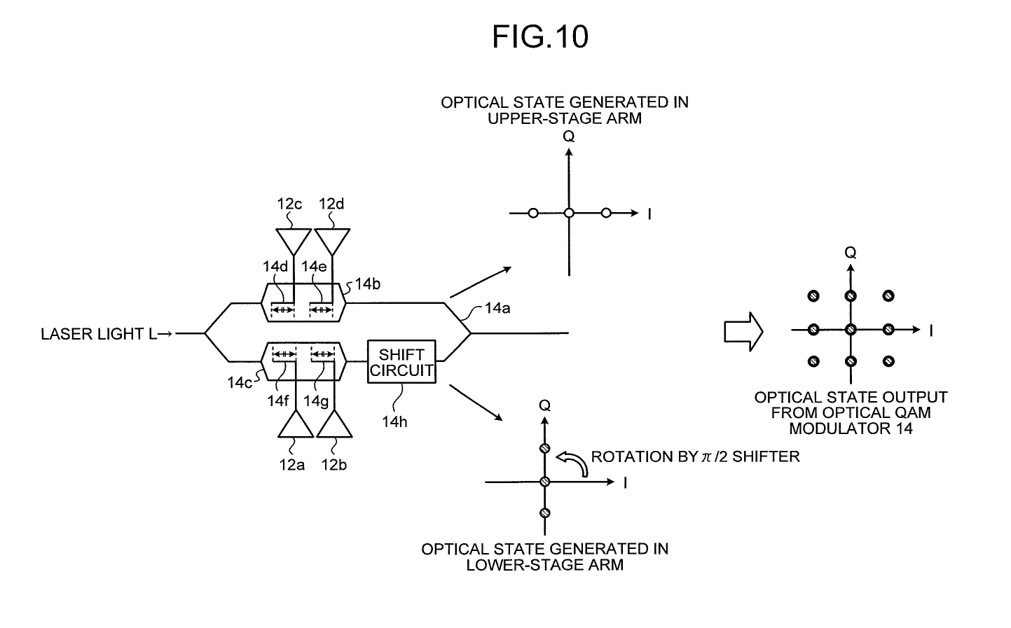

FIG. 10 is a diagram illustrating one example of a configuration of the optical QAM modulator 14 according to modification 3. As illustrated in FIG. 10, when two lights with the above phase difference are synthesized at the time of the output from the second Mach-Zehnder 14c, three optical states (i.e. three values) are generated. In modification 3, unlike the example illustrated in FIG. 5, the optical phase difference between the arms of the second Mach-Zehnder 14c has the identical value in cases where the electric potentials of the electrodes 14f and 14g are “1” and “0” and where the electric potentials of the electrodes 14f and 14g are “0” and “1.” Therefore, there can be three kinds of optical phase differences acquired by combinations of the electric potentials of the electrodes 14f and 14g. Further, since the phase difference of the output light from one second Mach-Zehnder 14c is shifted by n/2, when it is synthesized with the output light from the other second Mach-Zehnder 14b at the time of the output from the first Mach-Zehnder 14a, optical QAM modulation by 9(=3×3) QAM is performed. Such orthogonal duo-binary modulation has high wavelength dispersion resistance.

Modification 4

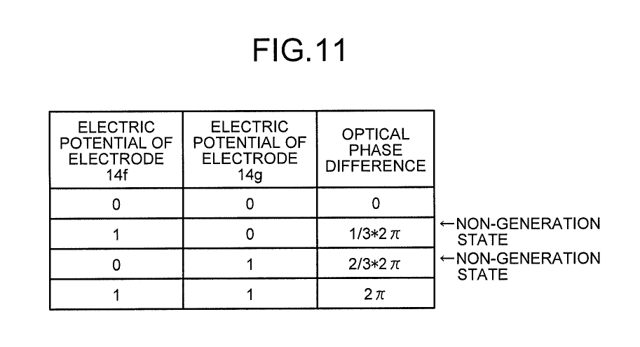

Further, as another variation aspect, the optical QAM modulator 14 that performs 2ⁿ×2ⁿ-QAM modulation can realize 2ⁿ⁻¹×2ⁿ⁻¹-QAM modulation when the output signals from the drive circuits 12a and 12b are identical and the output signals from the drive circuits 12c and 12d are identical. FIG. 11 is a diagram illustrating one example of a relationship between the electric potentials of the electrodes 14f and 14g and an optical phase difference in a case where the optical QAM modulator 14 according to modification 4 performs 2ⁿ⁻¹×2ⁿ⁻¹-QAM modulation. Since signals input from the drive circuits 12a and 12b to the electrodes 14f and 14g are identical, the electric potentials of the electrodes 14f and 14g have the identical value (i.e. “0” or “1”). As a result, the optical phase difference between the arms of the second Mach-Zehnder 14c is as illustrated in FIG. 11. That is, an optical phase state is not generated in which the electric potentials of the electrodes 14f and 14g are different, and therefore there are two kinds of optical phase differences of “0” and “2π.” Accordingly, the optical QAM modulator 14 can perform 4-QAM modulation (in the case of n=2).

By utilizing such a characteristic, the optical transmission device 2 can change a modulation scheme from, for example, the 16-QAM modulation scheme to the 4-QAM modulation scheme according to an input scheme selection signal. According to the optical transmission device 2 according to modification 4, even in a case where the optical transmission device 3 on the reception side is an old-type device corresponding to only the 4-QAM modulation scheme, it is possible to transmit and receive optical signals by changing a modulation scheme of the optical transmission device 2 on the transmission side according to the reception side. Therefore, the optical transmission device 2 can flexibly cope with various optical transmission devices according to the modulation number on the reception side. As a result, the general versatility of the optical transmission system 1 improves.

Also, in the above explanation, individual configurations and operations have been described every embodiment and modification. However, the optical transmission device 2 according to the embodiment and each modification may include components unique to other modifications. Also, regarding a combination of the embodiment and each modification, it is not limited to a combination of two items but can adopt an arbitrary form such as a combination of three or more items. For example, the optical transmission device 2 according to modifications 1, 3 and 4 may include the polarization distributor 19 according to modification 2 to diffuse the output light from the CWLD 13. Also, the optical transmission device 2 according to modifications 1 to 3 may have a function of switching a modulation scheme based on a scheme selection signal.

According to one aspect of an optical transmitter disclosed in the present application, it is possible to suppress degradation of optical transmission quality without increasing the number of parts.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmitter comprising:
a first Mach-Zehnder-type optical waveguide formed in an LN (Lithium Niobate) substrate;
second Mach-Zehnder-type optical waveguides formed in branch waveguides of the first Mach-Zehnder-type optical waveguide;
a plurality of electrodes that are set in the second Mach-Zehnder-type optical waveguides and modulate lights input in the second Mach-Zehnder-type optical waveguides using an electric potential of the electrodes; and
a shift circuit that causes a phase difference between the lights modulated in the plurality of electrodes and output from the second Mach-Zehnder-type optical waveguides,
wherein the first Mach-Zehnder-type optical waveguide synthesizes the lights of different phases and generates an output signal.

2. The optical transmitter according to claim 1, further comprising:
a plurality of drive circuits that give an electric potential to the plurality of electrodes;
a monitoring circuit that monitors a power based on a light output from the first Mach-Zehnder-type optical waveguide; and
a correction circuit that corrects a phase difference between signals output from the plurality of drive circuits using a value of the power.

3. The optical transmitter according to claim 1, further comprising a distributor that diffuses an input laser light, generates two orthogonal polarization lights, and outputs the polarization lights to the branch waveguides of the first Mach-Zehnder-type optical waveguide.

4. The optical transmitter according to claim 2, wherein
the plurality of drive circuits output signals of different amplitudes to the plurality of electrodes, and
the plurality of electrodes perform orthogonal duo-binary modulation on the light using the signals of different amplitudes and the electric potential of the electrodes.

5. An optical transmission method comprising:
modulating lights input in second Mach-Zehnder-type optical waveguides formed in branch waveguides of a first Mach-Zehnder-type optical waveguide formed in an LN (Lithium Niobate) substrate, using an electric potential of a plurality of electrodes set in the second Mach-Zehnder-type optical waveguides;
causing a phase difference between the lights modulated in the plurality of electrodes and output from the second Mach-Zehnder-type optical waveguides; and
synthesizing the lights of different phases and generate an output signal.
